(19) United States
(12) Patent Application Publication
(10) Pub. No.: US 2018/0109577 A1
(43) Pub. Date: Apr. 19, 2018

(54) SYSTEMS AND METHODS FOR ENABLING COMMUNICATIONS ASSOCIATED WITH DIGITAL MEDIA DISTRIBUTION

(71) Applicant: Sharp Laboratories of America, Inc., Camas, WA (US)

(72) Inventor: Sachin G. DESHPANDE, Camas, WA (US)

(73) Assignee: Sharp Laboratories of America, Inc., Camas, WA (US)

(21) Appl. No.: 15/782,617

(22) Filed: Oct. 12, 2017

Related U.S. Application Data
(60) Provisional application No. 62/408,008, filed on Oct. 13, 2016.
(60) Provisional application No. 62/462,194, filed on Feb. 22, 2017.

(51) Int. Cl. H04L 29/06; H04N 21/647

(52) U.S. Cl. CPC H04L 65/4084; H04L 67/02; H04L 69/22; H04N 21/647

(57) ABSTRACT

A device may be configured to signal a frame header indicating a Dynamic adaptive streaming over Hypertext Transfer Protocol message type and signal one or more supplied arguments corresponding to the message type, as JavaScript Object Notation encoded parameters.

### RELATED APPLICATIONS

This application claims the benefit of U.S. Provisional Application No. 62/408,008, filed on Oct. 13, 2016; and U.S. Provisional Application No. 62/462,194, filed on Feb. 22, 2017, each of which are incorporated by reference in their respective entireties.

### TECHNICAL FIELD

The present disclosure relates to the field of digital media distribution.

### BACKGROUND

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packet-switched networks, including bidirectional networks, such as Internet Protocol (IP) networks and unidirectional networks, such as digital broadcast networks.

Digital media content may be transmitted from a source to a receiver device (e.g., a digital television or a smart phone) according to a content delivery protocol model. A content delivery protocol model may be based on one or more transmission standards. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 3.0 suite of standards currently under development. Current techniques for transmitting digital media content from a source to a receiver device may be less than ideal.

### SUMMARY

In general, this disclosure describes techniques for enabling communications associated with distribution of digital media content. It should be noted that digital media content may be included as part of an audio-visual service or in some examples may be included as a dedicated audio service. It should be noted that although in some examples the techniques of this disclosure are described with respect to particular transmission standards and particular digital media formats, the techniques described herein may be generally applicable to various transmission standards and digital media formats. For example, the techniques described herein may be generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband Television (HbbTV) standards, World Wide Web Consortium (W3C) standards, Universal Plug and Play (UPnP) standards, and Moving Pictures Expert Group (MPEG) standards. Further, it should be noted that incorporation by reference of documents herein is for descriptive purposes and should not be constructed to limit and/or create ambiguity with respect to terms used herein. For example, in the case where one incorporated reference provides a different definition of a term than another incorporated reference and/or as the term is used herein, the term should be interpreted in a manner that broadly includes each respective definition and/or in a manner that includes each of the particular definitions in the alternative.

According to one example of the disclosure, a method for signaling information associated with a media presentation, comprises signaling a frame header indicating a Dynamic adaptive streaming over Hypertext Transfer Protocol message type, and signaling one or more supplied arguments corresponding to the message type as JavaScript Object Notation encoded parameters.

According to another example of the disclosure, a device for signaling information associated with a media presentation comprises one or more processors configured to signal a frame header indicating a Dynamic adaptive streaming over Hypertext Transfer Protocol message type, and signal one or more supplied arguments corresponding to the message type as JavaScript Object Notation encoded parameters.

According to another example of the disclosure, an apparatus signaling information associated with a media presentation comprises means for signaling a frame header indicating a Dynamic adaptive streaming over Hypertext Transfer Protocol message type, and means for signaling one or more supplied arguments corresponding to the message type as JavaScript Object Notation encoded parameters.

According to another example of the disclosure, a non-transitory computer-readable storage medium comprises instructions stored thereon that upon execution cause one or more processors of a device to signal a frame header indicating a Dynamic adaptive streaming over Hypertext Transfer Protocol message type, and signal one or more supplied arguments corresponding to the message type, as JavaScript Object Notation encoded parameters.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example of a content delivery protocol model according to one or more techniques of this disclosure.

FIG. 2 is a block diagram illustrating an example of a system that may implement one or more techniques of this disclosure.

FIG. 3 is a block diagram illustrating an example of a computing device that may implement one or more techniques of this disclosure.

FIG. 4 is a block diagram illustrating an example of a media distribution engine that may implement one or more techniques of this disclosure.

FIG. 5 is a conceptual diagram illustrating an example of a communications flow according to one or more techniques of this disclosure.

FIGS. 6A-6B are computer program listings illustrating respective example schemas of a media presentation document request message.

FIGS. 7A-7D are computer program listings illustrating respective example schemas of a media presentation document request response message.

FIGS. 8A-8B are computer program listings illustrating respective example schemas of a segment request message.

FIGS. 9A-9F are computer program listings illustrating respective example schemas of a segment request response message.

FIGS. 10A-10B are computer program listings illustrating respective example schemas of a cancellation request message.

FIGS. 11A-11B are a computer program listing illustrating respective example schemas of a resource change notification message.

### DETAILED DESCRIPTION

Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model. The OSI model defines a 7-layer stack model, including an application layer, a presentation layer, a session layer, a transport layer, a network layer, a data link layer, and a physical layer. It should be noted that the use of the terms upper and lower with respect to describing the layers in a stack model may be based on the application layer being the uppermost layer and the physical layer being the lowermost layer. Further, in some cases, the term “Layer 1” or “L1” may be used to refer to a physical layer, the term “Layer 2” or “L2” may be used to refer to a link layer, and the term “Layer 3” or “L3” or “IP layer” may be used to refer to the network layer.

A physical layer may generally refer to a layer at which electrical signals form digital data. For example, a physical layer may refer to a layer that defines how modulated radio frequency (RF) symbols form a frame of digital data. A data link layer, which may also be referred to as link layer, may refer to an abstraction used prior to physical layer processing at a sending side and after physical layer reception at a receiving side. As used herein, a link layer may refer to an abstraction used to transport data from a network layer to a physical layer at a sending side and used to transport data from a physical layer to a network layer at a receiving side. It should be noted that a sending side and a receiving side are logical roles and a single device may operate as both a sending side in one instance and as a receiving side in another instance. A link layer may abstract various types of data (e.g., video, audio, or application files) encapsulated in particular packet types (e.g., Internet Protocol Version 4 (IPv4) packets, etc.) into a single generic format for processing by a physical layer. A network layer may generally refer to a layer at which logical addressing occurs. That is, a network layer may generally provide addressing information (e.g., IP addresses) such that data packets can be delivered to a particular node (e.g., a computing device) within a network. As used herein, the term network layer may refer to a layer above a link layer and/or a layer having data in a structure such that it may be received for link layer processing. A transport layer may refer to a layer enabling so-called process-to-process communication services. Each of a session layer, a presentation layer, and an application layer may define how data is delivered for use by a user application. Transmission standards, including transmission standards currently under development, may include a content delivery protocol model specifying supported protocols for each layer and may further define one or more specific layer implementations.

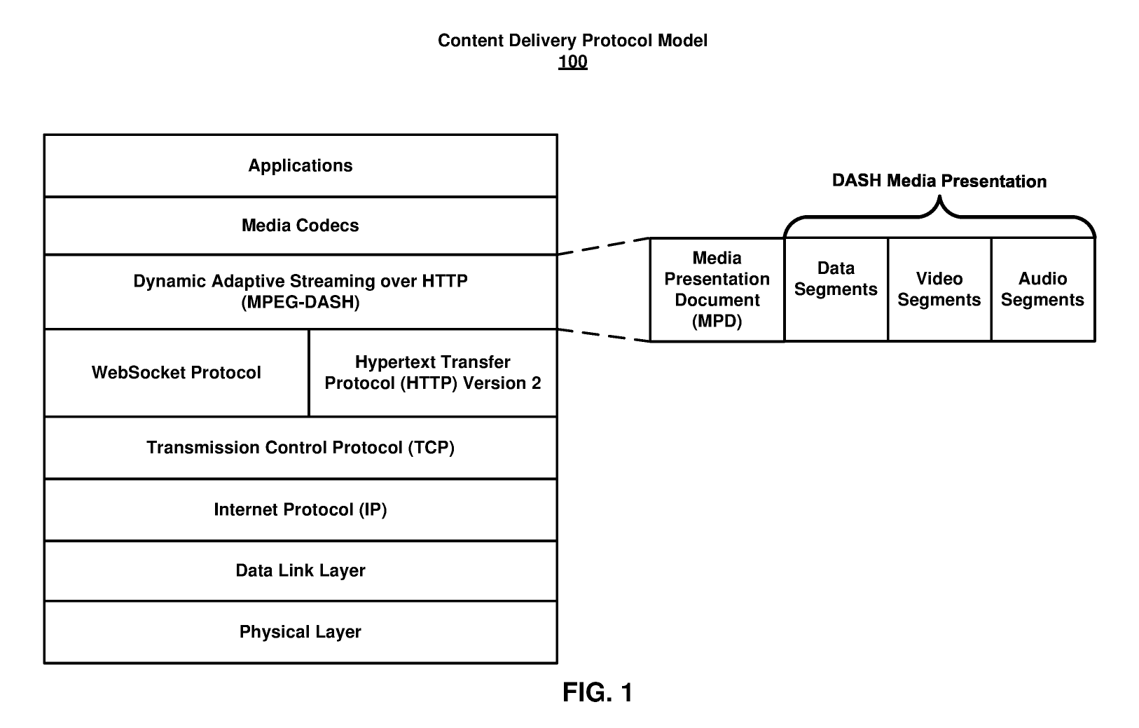

FIG. 1 illustrates an example of a content delivery protocol model in accordance with the techniques described herein. The techniques described herein may be implemented in a system configured to operate based on content delivery protocol model 100. Content delivery protocol model 100 may enable distribution of digital media content. As such, content delivery protocol model 100 may be implemented in a system enabling a user to access digital media content from a media service provider (e.g., a so-called streaming service). The term media service or media presentation may be used to refer to a collection of media components presented to the user in aggregate (e.g., a video component, an audio component, and a sub-title component), where components may be of multiple media types, where a service can be either continuous or intermittent, where a service can be a real time service (e.g., multimedia presentation corresponding to a live event) or a non-real time service (e.g., a video on demand service).

As illustrated in FIG. 1, content delivery protocol model 100 includes a physical layer and a data link layer. As described above, a physical layer may generally refer to a layer at which electrical signals form digital data and a data link layer may include a generic format for processing by physical layer. In the example illustrated in FIG. 1, in some examples, physical layer may include a physical layer frame structure including a defined preamble and data payload structure including one logical structure within an RF channel or a portion of an RF channel. In the example illustrated in FIG. 1, data link layer may be a data structure used to abstract various particular packet types into a single generic format for processing by a physical layer. As described above, a network layer may generally refer to a layer at which logical addressing occurs. Referring to FIG. 1, content delivery protocol model 100 may utilize IP addressing schemes, e.g., IPv4 and/or IPv6 as a network layer. As described above, a transport layer may generally refer to a layer enabling so-called process-to-process communication services. As illustrated in FIG. 1, content delivery protocol model 100 may utilize Transport Control Protocol (TCP) as a transport layer.

As described above, content delivery protocol model 100 may enable distribution of digital media content. In the example of FIG. 1, applications may include applications enabling a user to cause digital media content to be rendered. For example, content delivery protocol model may include a video player application operating on a mobile device or the like. In the example illustrated in FIG. 1, media codecs may include the underlying codecs (i.e., multimedia encoder/decoder implementations) that enable digital media content formats (e.g., MPEG formats, etc.) to be rendered by an application. In the example illustrated in FIG. 1, content delivery protocol model 100 utilizes Dynamic adaptive streaming over HTTP (DASH) to enable a logical client to receive digital media content from a logical server. DASH is described in DASH-IF profile of MPEG DASH ISO/IEC: ISO/IEC 23009-1:2014, “Information technology—Dynamic adaptive streaming over HTTP (DASH)—Part 1: Media presentation description and segment formats,” International Organization for Standardization, 2nd Edition, May 15, 2014 (hereinafter, “ISO/IEC 23009-1:2014”), which is incorporated by reference herein. As illustrated in FIG. 1, a DASH media presentation may include data segments, video segments, and audio segments. In some examples, a DASH Media Presentation may correspond to a linear service or part of a linear service of a given duration defined by a service provider (e.g., a single TV program, or the set of contiguous linear TV programs over a period of time). According to DASH, a Media Presentation Document (MPD) is a metadata fragment that includes a formalized description of a profile of a DASH Media Presentation. A fragment may include a set of eXtensible Markup Language (XML)-encoded metadata fragments. The contents of the MPD provide the resource identifiers for segments and the context for the identified resources within the Media Presentation. The data structure and semantics of the MPD fragment are described with respect to ISO/IEC 23009-1:2014. Further, it should be noted that draft editions of ISO/IEC 23009-1 are currently being proposed. Thus, in the example illustrated in FIG. 1, a MPD may include a MPD as described in ISO/IEC 23009-1:2014, currently proposed MPDs, and/or combinations thereof.

In ISO/IEC 23009-1:2014, a media presentation as described in a MPD may include a sequence of one or more Periods, where each Period may include one or more Adaptation Sets. It should be noted that in the case where an Adaptation Set includes multiple media content components, then each media content component may be described individually. Each Adaptation Set may include one or more Representations. In ISO/IEC 23009-1:2014 each Representation is provided: (1) as a single Segment, where Subsegments are aligned across Representations with an Adaptation Set; and (2) as a sequence of Segments where each Segment is addressable by a template-generated Universal Resource Locator (URL). The properties of each media content component may be described by an AdaptationSet element and/or elements within an Adaption Set, including for example, a ContentComponent element.

As illustrated in FIG. 1, DASH may operate on top of HTTP and WebSocket Protocols. That is, DASH media presentations may be carried over full duplex HTTP-compatible protocols, including HTTP/2, which is described in Internet Engineering Task Force (IETF) Request for Comment (RFC) 7540, Hypertext Transfer Protocol Version 2 (HTTP/2), May 2015 and WebSocket Protocol, which is described in IETF: “The WebSocket Protocol,” RFC 6455, Internet Engineering Task Force, December 2011, and the WebSocket API, World Wide Web Consortium (W3C) Candidate Recommendation, 20 Sep. 2012, each of which are respectively incorporated by reference herein.

WebSocket Protocol enables two-way communication between a logical client and a logical server (which may be referred to as a remote host) through the establishment of a bidirectional socket. It should be noted that in some cases, a side or endpoint of a bidirectional socket may be referred to as a terminal. A bidirectional socket based on the WebSocket protocol includes a bidirectional socket that enables character data encoded in Universal Transformation Format-8 (UTF-8) to be exchanged between a logical client and a logical server over TCP. Draft International Standard for 23009-6: DASH with Server Push and WebSockets, ISO/IEC JTC1/SC29/WG11/W16232, June 2016, (hereinafter “W16232”), which is incorporated by reference herein, defines the signaling and message formats for driving the delivery of MPEG-DASH media presentations using a bidirectional socket based on the WebSocket protocol. Study of ISO/IEC Draft International Standard for 23009-6: DASH with Server Push and WebSockets, ISO/IEC JTC1/SC29/WG11/W16666, January 2017, (hereinafter “W16666”), which is incorporated by reference herein, defines the signaling and message formats for driving the delivery of MPEG-DASH media presentations using a bidirectional socket based on the WebSocket protocol.

In W16232, the transmission of a segment from server to client (referred to as a push in W16232) is based on a push strategy, that defines the ways in which segments may be transmitted from a server to a client. In W16232, a push directive is a request modifier, sent from a client to a server, which enables a client to express its expectations regarding the server's push strategy for processing a request. Further, in W16232, a push acknowledgement (also referred to as a Push Ack) is a response modifier, sent from a server to a client, which enables a server to state the push strategy used when processing a request. In W16232, push directives and push acknowledgements may be communicated by sending messages including a DASH sub-protocol frame header and one or more supplied arguments. The semantics of the DASH sub-protocol frame header as provided in W16232 are provided in Table 1.

TABLE 1

| | |
|---|---|
| Syntax | No. of Bits |

Frame header( ) {

| | |
|---|---|
| STREAM_ID | 8 |
| MSG_CODE | 8 |
| E | 1 |
| F | 2 |
| EXT_LENGTH | 13 |
| Extension | 4*EXT_LENGTH |

}

W16232 provides the following definitions for each STREAM_ID, MSG_CODE, E, F, EXT_LENGTH, and Extension:

STREAM_ID: Is an identifier of the current stream, which allows multiplexing of multiple requests/responses over the same WebSocket connection. The responses to a particular request shall use the same STREAM_ID as that request. The appearance of a new STREAM_ID indicates that a new stream has been initiated. The reception of a cancel request, an end of stream, or an error shall result in closing the stream identified by the carried STREAM_ID.

MSG_CODE: Indicates the MPEG-DASH message represented by this frame. Available message codes are defined in Table 2.

TABLE 2

| Message | | | Supplied |
|---|---|---|---|
| Code | Message | Description | Arguments |
| 1 | get_mpd | The MPD request message initiates | Table 3 |
| | | the request for a DASH MPD file. | |
| | | One or more Push Directives may be | |
| | | provided with the MPD request. | |
| 2 | get_segment | The segment request message initiates the | Table 4 |
| | | request for a DASH segment. The segment | |
| | | request may include one or more Push | |
| | | Directives to inform the server to actively | |
| | | push one or more future segments. | |
| 3 | new_mpd | This message represents the server's | Table 5 |
| | | response from a previous get_mpd message | |
| | | sent by the client. | |
| 4 | new_segment | This message represents the server's | Table 6 |
| | | response from a previous get_segment | |
| | | message sent by the client. A server may | |
| | | issue multiple responses for a single request, | |
| | | as appropriate for the push strategy in the | |
| | | corresponding get_segment message. | |
| 5 | end_of_stream | This message is sent by the server to indicate | Table 7 |
| | | that a previous operation cannot be | |
| | | continued as a result of a change to resource | |
| | | availability or other condition. | |
| 255 | cancel | This message represents a client request for | Table 8 |
| | | the server to cancel the outstanding push | |
| | | transaction over a given WebSocket stream. | |

E: This field is the error flag. When this field is set the receiver may interpret the message as an error. Additional information about the error may be available in the extension header.

F: Reserved.

EXT_LENGTH: Provides the length in 4 bytes of the extension data that precedes the application data, including padding.

Extension: The extension header must be a JavaScript Object Notation (JSON) encoding of additional information fields that apply to the request/response, conforming to IETF RFC 7158, [The JavaScript Object Notation (JSON) Data Interchange Format, March 2013, which is incorporated by reference herein]. To align with 4 byte boundaries, padding 0 bytes may be added after the extension header. The content shall be encoded in UTF-8 format. The JSON encoding of the extension header shall consist of a single root level JSON object, containing zero or more name/value pairs.

As illustrated in Table 2, each message type includes supplied arguments which are illustrated in Tables 3-8. In each of Tables 3-8, Type indicates a data type, where URI is a string including a Uniform Resource Identifier (URI), as defined in RFC 3986, String is a UTF-8 character string, integer, and Boolean is a true or false value. In each of Tables 3-8, Cardinality indicates the required number of instances of a parameter in an instance of a message, where 0 indicates signaling of a parameter value is optional.

TABLE 3

| Parameter | | | |
|---|---|---|---|
| Name | Type | Cardinality | Description |
| mpd_uri | URI | 1 | the full URI for the MPD being |
| | | | requested |
| push_directive | PushDirective | 0 . . . N | A push strategy to be applied to this |
| | | | MPD request, as described in section |
| | | | 6.1.3 [of W16232] |
| headers | String | 0 . . . 1 | Contains a Carriage Return Line Feed |
| | | | (CRLF) separated set of HTTP 1.1 |
| | | | conformant header fields that apply |
| | | | to this message. |

TABLE 4

| Parameter | | | |
|---|---|---|---|
| Name | Type | Cardinality | Description |
| segment_uri | URI | 1 | the full URI for the video |
| | | | segment being requested |
| push_directive | PushDirective | 0 . . . N | the desired push strategy for |
| | | | getting following segments, as |
| | | | described in section 6.1.3 [of W16232]. |
| headers | String | 0 . . . 1 | Contains a CRLF separated set |
| | | | of HTTP 1.1 conformant header |
| | | | fields that apply to this message. |

TABLE 5

| Parameter | | | |
|---|---|---|---|
| Name | Type | Cardinality | Description |
| mpd | MDP | 1 | The MPD returned by the |
| | | | server |
| push_ack | PushAck | 0 . . . N | The push strategy that the |
| | | | server will follow, as |
| | | | described in section 6.1.4 [of |
| | | | W16232]. |
| headers | String | 0 . . . 1 | Contains a CRLF separated |
| | | | set of HTTP 1.1 conformant |
| | | | header fields that apply to |
| | | | this message. |
| status | Number | 1 | An HTTP status code, |
| | | | conforming to RFC 7231 |
| | | | [IETF RFC 7231, Hypertext |
| | | | Transfer Protocol |
| | | | (HTTP/1.1): Semantics and |
| | | | Content, June 2014] section |
| | | | 6, which applies to this |
| | | | message. |

TABLE 6

| Parameter | | | |
|---|---|---|---|
| Name | Type | Cardinality | Description |
| Segment | Segment | 1 | The segment returned by the server. |
| push_ack | PushAck | 0 . . . N | The push strategy that the server will |
| | | | follow, as described section in 6.1.4 [of |
| | | | W16232]. |
| headers | String | 0 . . . 1 | Contains a CRLF separated set of HTTP |
| | | | 1.1 conformant header fields that apply |
| | | | to this message. |
| status | Number | 1 | An HTTP status code, conforming to |
| | | | RFC 7231 section 6, which applies to |
| | | | this message. |

TABLE 7

| Parameter | | | |
|---|---|---|---|
| Name | Type | Cardinality | Description |
| headers | String | 0 . . . 1 | Contains a CRLF separated set of |
| | | | HTTP 1.1 conformant header fields |
| | | | that apply to the request |
| | | | corresponding to this stream. |

TABLE 8

| Parameter | | | |
|---|---|---|---|
| Name | Type | Cardinality | Description |
| immediate | Boolean | 1 | If true, the client indicates that it would like |
| | | | the server to stop transmission immediately. |
| | | | If false, the client indicates it would like the |
| | | | server to complete transmission of the |
| | | | currently pushed segment (if any) before |
| | | | cancelling the transaction. |
| headers | String | 0 . . . 1 | Contains a CRLF separated set of HTTP 1.1 |
| | | | conformant header fields that apply to the |
| | | | request corresponding to this stream. |

Referring to Tables 3 and 4, W16232 provides the following format for a PushDirective Parameter.
The format of a PushDirective in the ABNF [IETF RFC 5234, Augmented BNF [Backus-Naur Form] for Syntax Specifications: ABNF, January 2008] form is as follows:
PUSH_DIRECTIVE=PUSH_TYPE [OWS “;” OWS QVALUE]
PUSH_TYPE=<A PushType defined [BELOW]>
QVALUE=<a qvalue, as defined in RFC 7231>
‘OWS’ is defined in RFC7230 [IETF RFC 7230, Hypertext Transfer Protocol (HTTP/1.1): Message Syntax and Routing, June 2014], section 3.2.3 and represents optional whitespace.
When multiple push directives are applied to a request, a client may apply a quality value (“qvalue”) as is described for use in content negotiation in RFC 7231. A client may apply higher quality values to directives it wishes to take precedence over alternative directives with a lower quality value.
Note that these values are hints to the server, and do not imply that the server will necessarily choose the strategy with the highest quality value.

Referring to Tables 5 and 6, W16232 provides the following format for a PushAck.
The format of the PushAck in the ABNF form is as follows:
PUSH_ACK=PUSH_TYPE
Where PUSH_TYPE is defined [BELOW]

W16232 provides the following format for a PushType:
The format of a PushType in the ABNF form is as follows:
PUSH_TYPE=PUSH_TYPE_NAME [OWS “;” OWS PUSH_PARAMS]
PUSH_TYPE_NAME=DQUOTE<URN>DQUOTE
PUSH_PARAMS=PUSH_PARAM*(OWS “;” OWS PUSH_PARAM)
PUSH_PARAM=1*VCHAR
Where
‘<URN>’ syntax is defined in RFC2141 [IETF RFC 2141, Uniform Resource Names (URN) Syntax, May 1997].

The messages defined for signaling push directives and push acknowledgements in W16232 may be less than ideal.

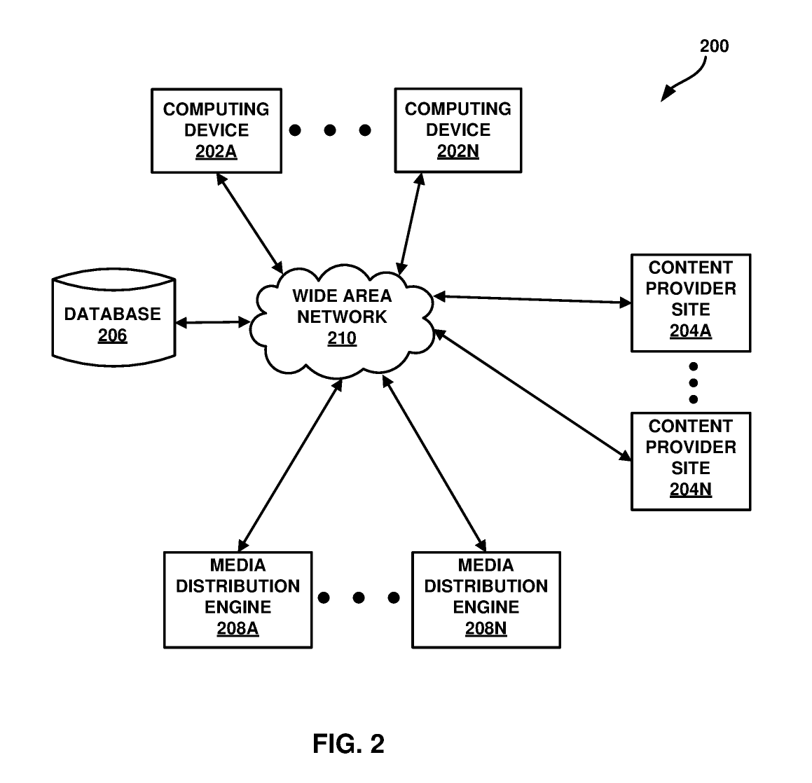

FIG. 2 is a block diagram illustrating an example of a system that may implement one or more techniques described in this disclosure. System 200 may be configured to communicate data in accordance with the techniques described herein. In the example illustrated in FIG. 2, system 200 includes one or more computing devices 202A-202N, one or more content provider sites 204A-204N, database 206, one or more media distribution engines 208A-208N, and wide area network 210. System 200 may include software modules. Software modules may be stored in a memory and executed by a processor. System 200 may include one or more processors and a plurality of internal and/or external memory devices. Examples of memory devices include file servers, file transfer protocol (FTP) servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

System 200 represents an example of a system that may be configured to allow digital media content, such as, for example, a movie, a live sporting event, etc., and data and applications and media presentations associated therewith, to be distributed to and accessed by a plurality of computing devices. In the example illustrated in FIG. 2, computing devices 202A-202N may include any device equipped for wired and/or wireless communications and may include televisions, set top boxes, digital video recorders, desktop, laptop, or tablet computers, gaming consoles, mobile devices, including, for example, “smart” phones, cellular telephones, and personal gaming devices. It should be noted that although system 200 is illustrated as having distinct sites, such an illustration is for descriptive purposes and does not limit system 200 to a particular physical architecture. Functions of system 200 and sites included therein may be realized using any combination of hardware, firmware and/or software implementations.

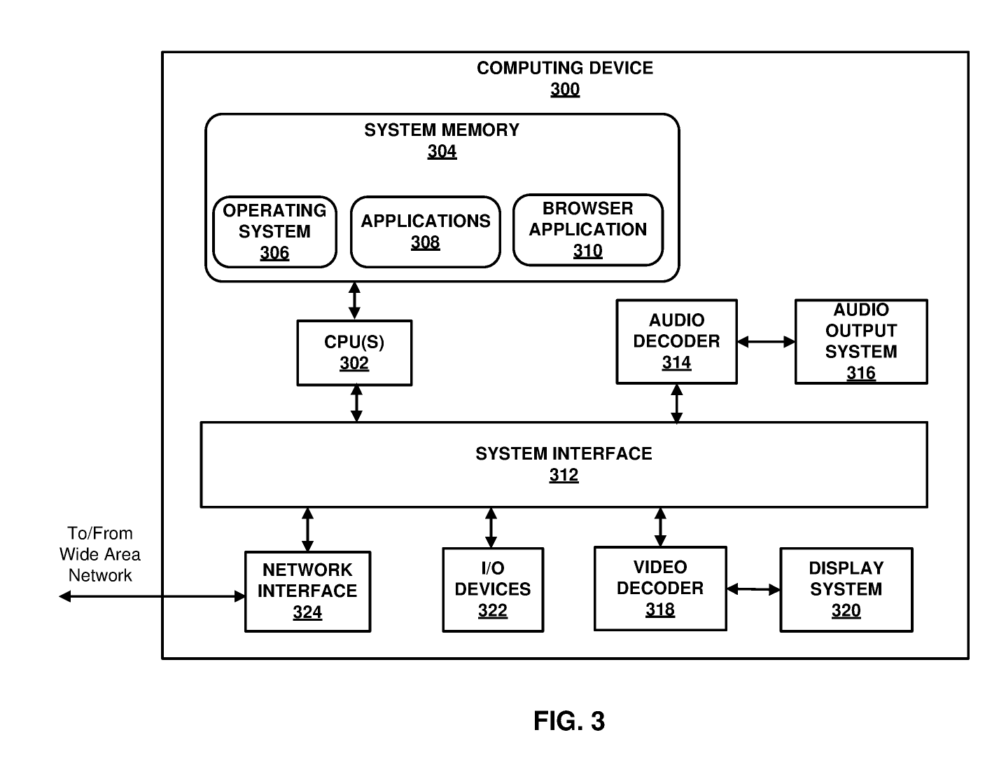

FIG. 3 is a block diagram illustrating an example of a computing device that may implement one or more techniques of this disclosure. Computing device 300 is an example of a computing device that may be configured to receive data from a communications network and allow a user to access multimedia content. Computing device 300 includes central processing unit(s) 302, system memory 304, system interface 312, audio decoder 314, audio output system 316, video decoder 318, display system 320, I/O device(s) 322, and network interface 324. Each of central processing unit(s) 302, system memory 304, system interface 312, audio decoder 314, audio output system 316, video decoder 318, display system 320, I/O device(s) 322, and network interface 324 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although computing device 300 is illustrated as having distinct functional blocks, such an illustration is for descriptive purposes and does not limit computing device 300 to a particular hardware architecture. Functions of computing device 300 may be realized using any combination of hardware, firmware and/or software implementations.

CPU(s) 302 may be configured to implement functionality and/or process instructions for execution in computing device 300. CPU(s) 302 may include single and/or multi-core central processing units. CPU(s) 302 may be capable of retrieving and processing instructions, code, and/or data structures for implementing one or more of the techniques described herein. Instructions may be stored on a computer readable medium, such as system memory 304. System memory 304 may be described as a non-transitory or tangible computer-readable storage medium. In some examples, system memory 304 may provide temporary and/or long-term storage. In some examples, system memory 304 or portions thereof may be described as non-volatile memory and in other examples portions of system memory 304 may be described as volatile memory. System memory 304 may be configured to store information that may be used by computing device 300 during operation. System memory 304 may be used to store program instructions for execution by CPU(s) 302 and may be used by programs running on computing device 300 to temporarily store information during program execution. Further, system memory 304 may be configured to store numerous digital media content files.

As illustrated in FIG. 3, system memory 304 includes operating system 306, applications 308, and browser application 310. Applications 308 may include applications implemented within or executed by computing device 300 and may be implemented or contained within, operable by, executed by, and/or be operatively/communicatively coupled to components of computing device 300. Applications 308 may include instructions that may cause CPU(s) 302 of computing device 300 to perform particular functions. Applications 308 may include algorithms which are expressed in computer programming statements, such as, for-loops, while-loops, if-statements, do-loops, etc. Applications 308 may be developed using a specified programming language. Examples of programming languages include, Java™, Jini™, C, C++, Objective C, Swift, Perl, Python, PhP, UNIX Shell, Visual Basic, and Visual Basic Script. Browser application 310 includes a logical structure that enables a computing device 300 to retrieve data using resource identifiers and/or cause retrieved data to be rendered. Browser application 310 may include one or more web browsers. Browser application 310 may be configured to process documents that generally correspond to website content, such as for example, mark-up language documents (e.g. HTML5, XML, etc.), and scripting language documents (e.g. JavaScript, etc.). Applications 308 and browser application 310 may execute in conjunction with operating system 306. That is, operating system 306 may be configured to facilitate the interaction of applications with CPUs(s) 302, and other hardware components of computing device 300. In some examples, operating system 306 may be an operating system designed to be installed on set-top boxes, digital video recorders, televisions, and the like. Further, in some examples, operating system 306 may be an operating system designed to be installed on dedicated computing devices and/or mobile computing devices. It should be noted that techniques described herein may be utilized by devices configured to operate using any and all combinations of software architectures.

System interface 312 may be configured to enable communications between components of computing device 300. In one example, system interface 312 comprises structures that enable data to be transferred from one peer device to another peer device or to a storage medium. For example, system interface 312 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, computing device 300 is a computing device configured to receive data from a communications network and extract digital media content therefrom. Extracted digital media content may be encapsulated in various packet types. Network interface 324 may be configured to enable computing device 300 to send and receive data via a local area network and/or a wide area network. Network interface 324 may include a network interface card, such as an Ethernet card, an optical transceiver, a radio frequency transceiver, or any other type of device configured to send and receive information. Network interface 324 may be configured to perform physical signaling, addressing, and channel access control according to the physical and Media Access Control (MAC) layers utilized in a network. Computing device 300 may be configured to parse a signal generated according to any of the techniques described herein.

Audio decoder 314 may be configured to receive and process audio packets. For example, audio decoder 314 may include a combination of hardware and software configured to implement aspects of an audio codec. That is, audio decoder 314 may be configured to receive audio packets and provide audio data to audio output system 316 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 316 may be configured to render audio data. For example, audio output system 316 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 318 may be configured to receive and process video packets. For example, video decoder 318 may include a combination of hardware and software used to implement aspects of a video codec. In one example, video decoder 318 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 Advanced video Coding (AVC)), and High-Efficiency Video Coding (HEVC). Display system 320 may be configured to retrieve and process video data for display. For example, display system 320 may receive pixel data from video decoder 318 and output data for visual presentation. Further, display system 320 may be configured to output graphics in conjunction with video data, e.g., graphical user interfaces. Display system 320 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 322 may be configured to receive input and provide output during operation of computing device 300. That is, I/O device(s) 322 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 322 may be operatively coupled to computing device 300 using a standardized communication protocol, such as for example, Universal Serial Bus protocol (USB), Bluetooth, ZigBee or a proprietary communications protocol, such as, for example, a proprietary infrared communications protocol.

Referring again to FIG. 2, wide area network 210 is an example of a network configured to enable digital media content to be distributed. Wide area network 210 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3^{rd} Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 210 may comprise any combination of wireless and/or wired communication media. Wide area network 210 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 210 may generally correspond to the Internet and sub-networks thereof.

Further, wide area network 210 may include radio and television service networks may include public over-the-air transmission networks, public or subscription-based satellite transmission networks, and public or subscription-based cable networks and/or over the top or Internet service providers. Wide area network 210 may operate according to a combination of one or more telecommunication protocols associated with radio and television service networks. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 2, content provider sites 204A-204N represent examples of sites that may originate multimedia content. For example, a content provider site may include a studio having one or more studio content servers configured to provide multimedia files and/or streams to a media distribution engine and/or a database. Database 206 may include storage devices configured to store data including, for example, multimedia content and data associated therewith, including for example, descriptive data and executable interactive applications. Data associated with multimedia content may be formatted according to a defined data format, such as, for example, Hypertext Markup Language (HTML), Dynamic HTML, XML, and JSON, and may include URLs and URIs.

Media distribution engines 208A-208N may be configured to distribute digital media content via wide area network 210. For example, media distribution engines 208A-208N may be included at one or more broadcast stations, a cable television provider site, a satellite television provider site, an Internet-based television provider site, and/or so-called a streaming media service site. Media distribution engines 208A-208N may be configured to receive data, including, for example, multimedia content, interactive applications, and messages, and distribute data to computing devices 202A-202N through wide area network 210.

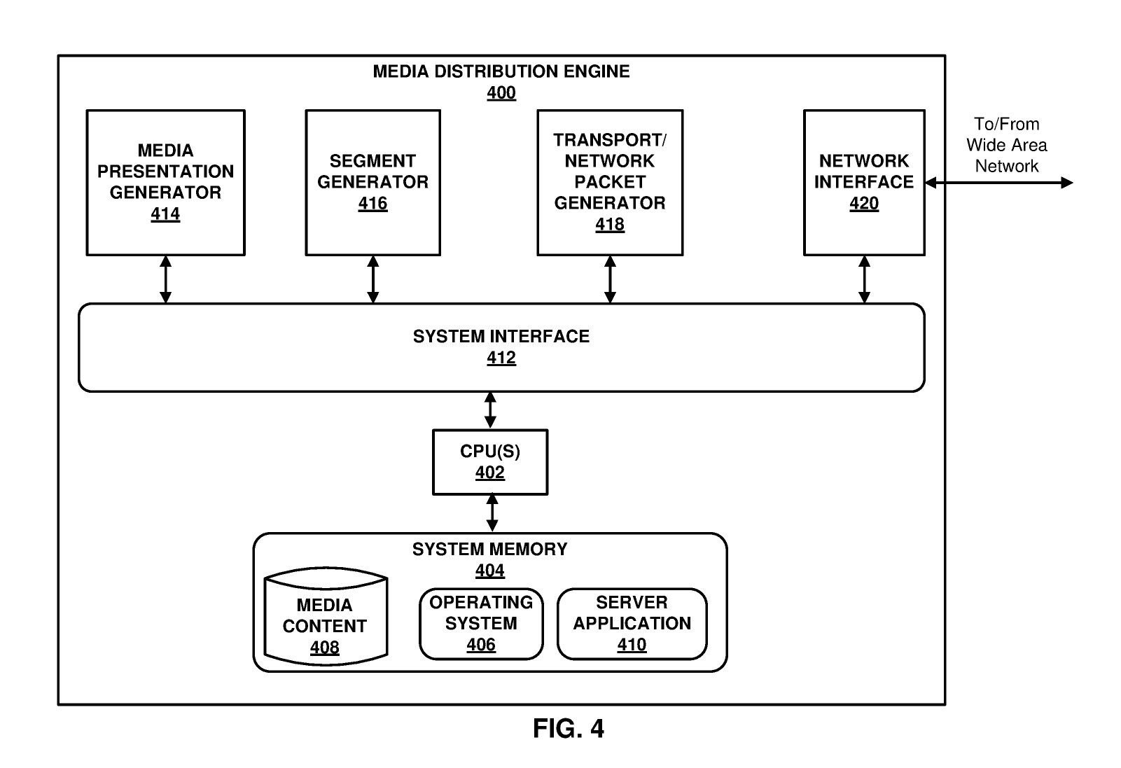

FIG. 4 is a block diagram illustrating an example of a media distribution engine that may implement one or more techniques of this disclosure. Media distribution engine 400 may be configured to receive data and output a signal representing data for distribution over a communication network, e.g., wide area network 210. For example, media distribution engine 400 may be configured to receive digital media content and output one or more data streams. A data stream may generally refer to data encapsulated in a set of one or more data packets. As illustrated in FIG. 4, media distribution engine 400 includes central processing unit(s) 402, system memory 404, system interface 412, media presentation description generator 414, segment generator 416, transport/network packet generator 418, and network interface 420. Each of central processing unit(s) 402, system memory 404, system interface 412, media presentation generator 414, segment generator 416, transport/network packet generator 418, and network interface 420 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although media distribution engine 400 is illustrated as having distinct functional blocks, such an illustration is for descriptive purposes and does not limit media distribution engine 400 to a particular hardware architecture. Functions of media distribution engine 400 may be realized using any combination of hardware, firmware and/or software implementations.

Each of central processing unit(s) 402, system memory 404, system interface 412 and network interface 420 may be similar to central processing unit(s) 302, system memory 304, system interface 312, and network interface 324 described above. CPU(s) 402 may be configured to implement functionality and/or process instructions for execution in media distribution engine 400. System interface 412 may be configured to enable communications between components of media distribution engine 400. Network interface 420 may be configured to enable media distribution engine 400 to send and receive data via a local area network and/or a wide area network. System memory 404 may be configured to store information that may be used by media distribution engine 400 during operation. It should be noted that system memory 404 may include individual memory elements within each of media presentation description generator 414, segment generator 416, and transport/network packet generator 418. For example, system memory 404 may include one or more buffers (e.g., First-in First-out (FIFO) buffers) configured to store data for processing by a component of media distribution engine 400.

As illustrated in FIG. 4, system memory includes operating system 406, media content 408, and server application 410. Operating system 406 may be configured to facilitate the interaction of applications with CPUs(s) 402 and other hardware components of media distribution engine 400. Media content 408 may include data forming a media presentation (e.g., video components, audio components, sub-title components, etc.). Media presentation generator 414 may be configured to receive one or more components and generate media presentations based on DASH. Further, media presentation generator 414 may be configured to generate media presentation description fragments. Segment generator 416 may be configured to receive media components and generate one or more segments for inclusion in a media presentation. Transport/network packet generator 418 may be configured to receive a transport package and encapsulate the transport package into corresponding transport layer packets (e.g., UDP, Transport Control Protocol (TCP), etc.) and network layer packets (e.g., Ipv4, Ipv6, compressed IP packets, etc.).

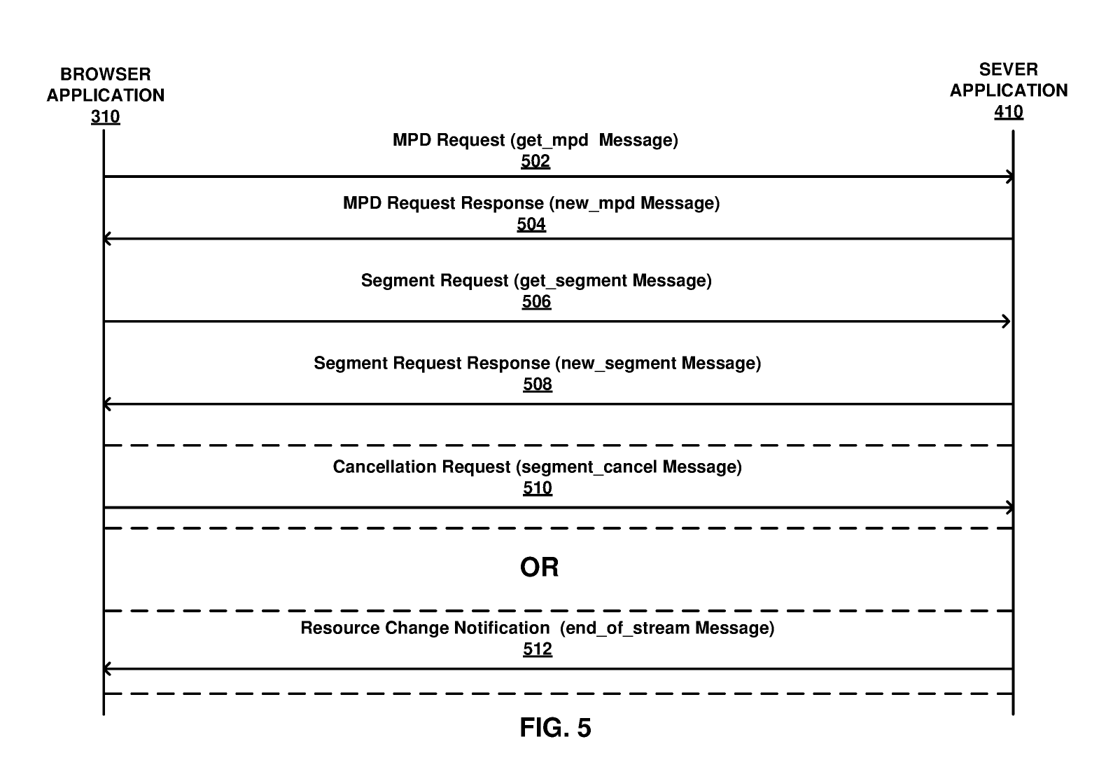

Referring again to FIG. 4, system memory 404 includes server application 410. As described above, WebSocket Protocol enables two-way communication between a logical client and a logical server through the establishment of a bidirectional socket. Server application 410 may include instructions that may cause CPU(s) 402 of media distribution engine 400 to perform particular functions associated with WebSocket Protocol. FIG. 5 is a conceptual diagram illustrating an example of a communications flow according to one or more techniques of this disclosure. FIG. 5 illustrates an example of a message flow for carrying an MPEG-DASH media presentation over a full duplex WebSocket session. As described above, messages defined for signaling push directives and push acknowledgements in W16232 may be less than ideal. Computing device 300 and media distribution engine 400 may be configured to exchange messages according to the techniques described herein.

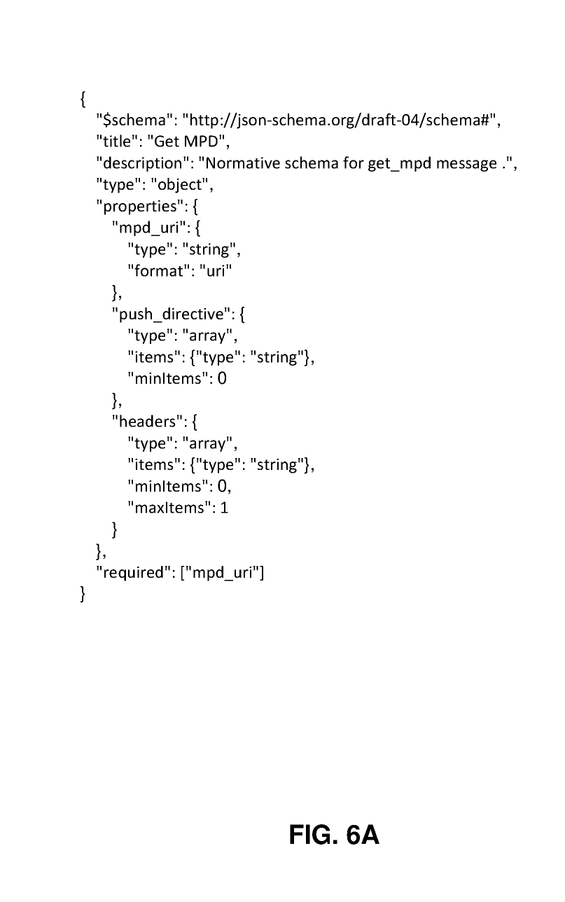

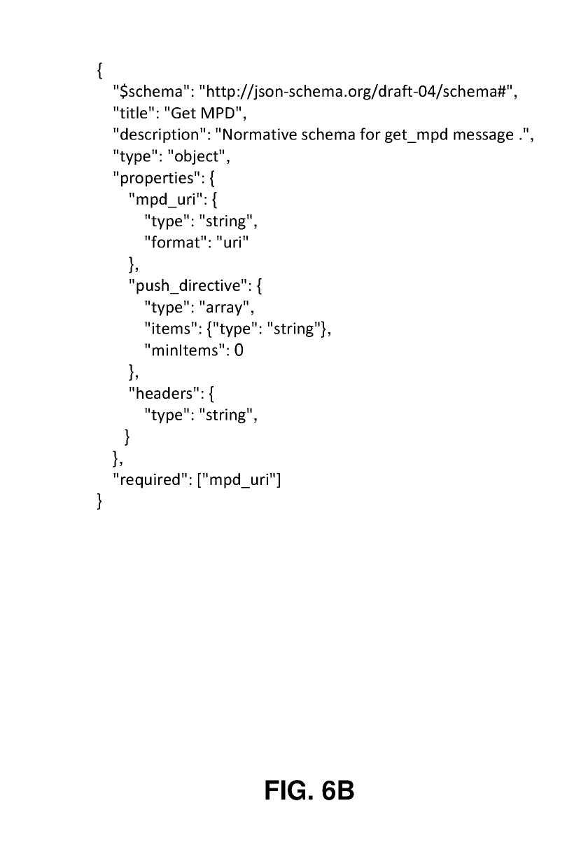

In the example illustrated in FIG. 5, at 502, browser application 310 sends a MPD Request to server application 410. In some examples, browser application 310 may be referred to as a client or a HTTP client, or a DASH client. Referring to Table 3, W16232 fails to define a normative JSON schema for the supplied arguments in Table 3. FIGS. 6A-6B are computer program listings illustrating respective example JSON schemas of a media presentation document request message. In one example, browser application 310 may be configured to send an MPD Request to server application 410 based on the example schemas illustrated in FIGS. 6A-6B.

Referring again to FIG. 5, at 504, server application 410 sends a MPD Request Response to browser application 310. Referring to Table 5, W16232 fails to define a normative JSON schema for the supplied arguments in Table 5. Further, in Table 5, parameter status includes a “Number” type in W16232. JSON data type “Number” supports integer and floating point numbers. With respect to an HTTP status code, floating point numbers are not necessary. Thus, in some examples, server application 410 may be configured to send response messages including parameter status using the JSON data type “Integer.” It should be noted that the JSON data type in this case may be called a “Integer” or “integer.” Referring again to Table 5, W16232 provides “mpd” as a parameter with type “MPD.” This does not completely specify how MPD is encoded as a JSON encoded parameter since it does not define what JSON data type is used. In one example, for the parameter “mpd” server application 410 may use JSON data type of “string” with having an encoding based on one of the following example requirements:

The media presentation description (MPD) data returned by the server shall be included in a JSON string after all occurrences of Line Feed (0x0A) are removed and all occurrences of double quote (0x22) are replaced with single quote (0x27).

OR

The media presentation description (MPD) data returned by the server shall be included in a JSON string after all occurrences of Line Feed (0x0A) are removed or escape coded.

OR

The media presentation description (MPD) data returned by the server shall be included in JSON string after applying escape coding.

Thus, in one example, server application 410 may send a MPD Request Response to browser application 310, where the format of the MPD Request Response is defined as provided in Table 9A. Further, in one example, server application 410 may send a MPD Request Response to browser application 310, where the format of the MPD Request Response is defined as provided in Table 9B.

TABLE 9A

| Parameter | | | |
|---|---|---|---|
| Name | Type | Cardinality | Description |
| mpd | String | 1 | The MPD returned by the |
| | | | server. The UTF-8 encoded |
| | | | XML MPD data shall be |
| | | | JSON encoded as specified |
| | | | by IETF RFC 7158 as JSON |
| | | | data type string. |
| push_ack | PushAck | 0 . . . N | The push strategy that the |
| | | | server will follow, as |
| | | | described in section 6.1.4 [of |
| | | | W16232]. |
| headers | String | 0 . . . 1 | Contains a CRLF separated |
| | | | set of HTTP 1.1 conformant |
| | | | header fields that apply to |
| | | | this message. |
| status | integer | 1 | An HTTP status code, |
| | | | conforming to RFC 7231 |
| | | | [IETF RFC 7231, Hypertext |
| | | | Transfer Protocol |
| | | | (HTTP/1.1): Semantics and |
| | | | Content, June 2014] section |
| | | | 6, which applies to this |
| | | | message. |

TABLE 9B

| Parameter | | | |
|---|---|---|---|
| Name | Type | Cardinality | Description |
| mpd | String | 1 | The MPD returned by the |
| | | | server. |
| push_ack | PushAck | 0 . . . 1 | The push strategy that the |
| | | | server will follow, e.g., as |
| | | | described in section 6.1.4 [of |
| | | | W16232 or W16666]. |
| headers | String | 0 . . . 1 | Contains a CRLF separated |
| | | | set of HTTP 1.1 conformant |
| | | | header fields that apply to |
| | | | this message. |
| status | integer | 1 | An HTTP status code, |
| | | | conforming to RFC 7231 |
| | | | [IETF RFC 7231, Hypertext |
| | | | Transfer Protocol |
| | | | (HTTP/1.1): Semantics and |
| | | | Content, June 2014] section |
| | | | 6, which applies to this |
| | | | message. |

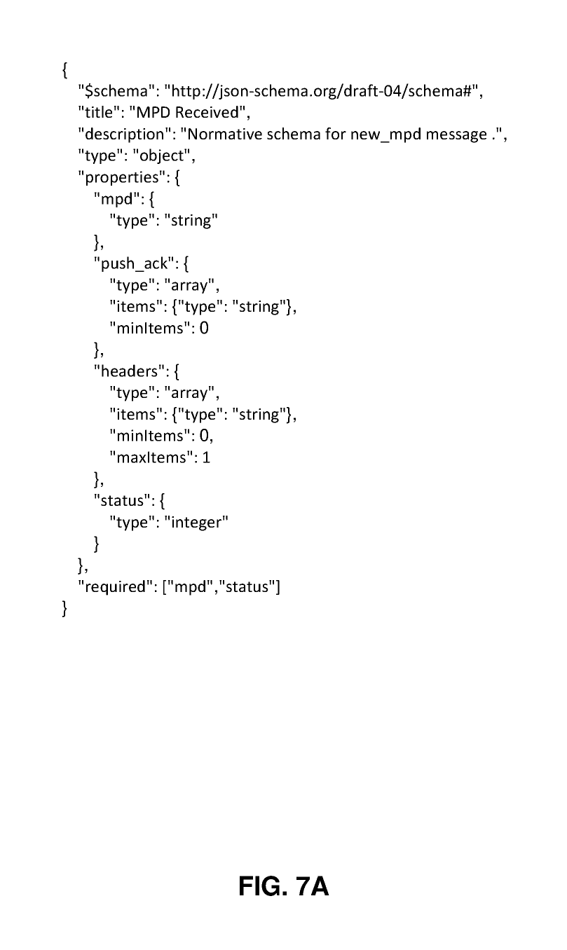

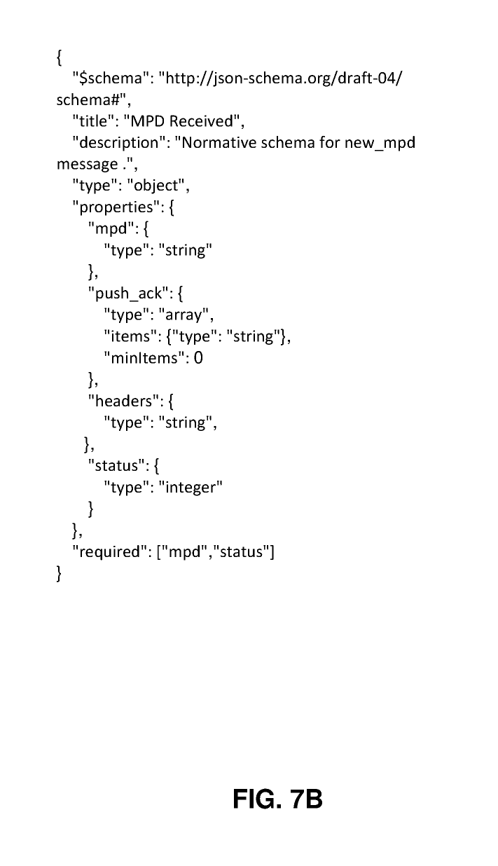

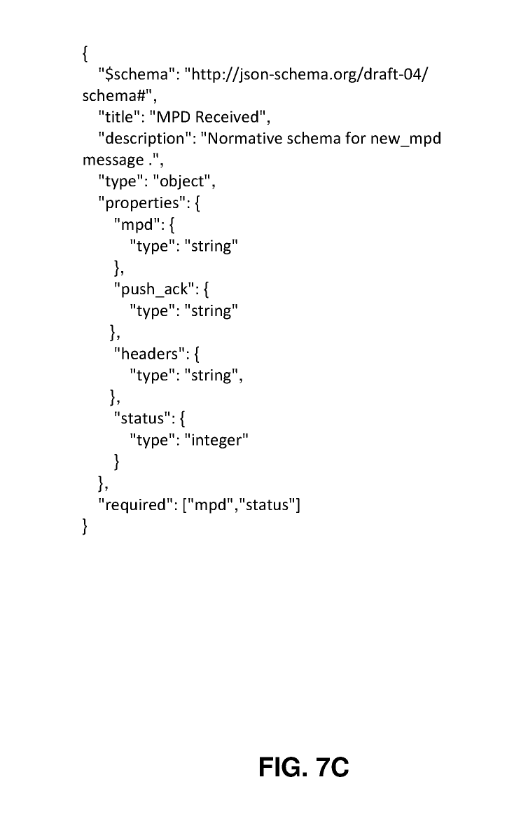

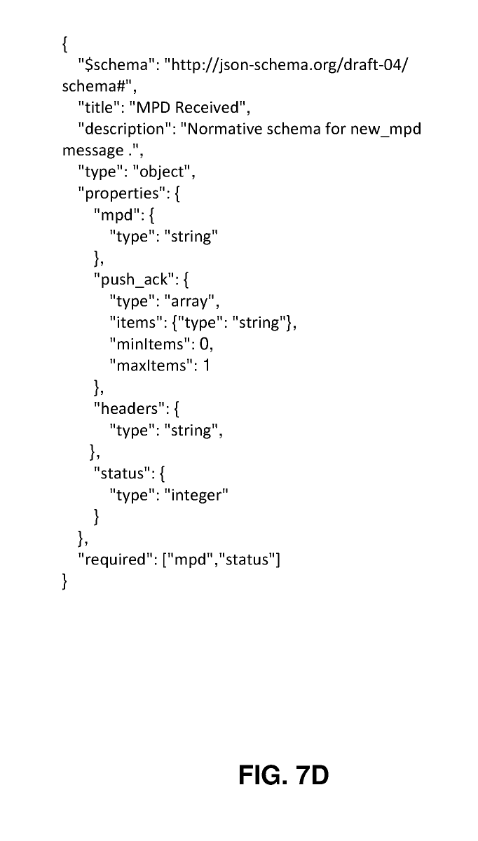

Further, FIGS. 7A-7D are computer program listings illustrating respective example schemas of a media presentation document request response message. In one example, server application 410 may be configured to send an MPD Request Response to browser application 310 based on the example schemas illustrated in FIGS. 7A-7D. It should be noted that in Table 9A push_ack has a cardinality of 0 . . . N (i.e., no maximum) and in Table 9B push_ack has a cardinality of 0 . . . 1 (i.e., a maximum of one). Thus, the example schemas illustrated in FIGS. 7A-7B correspond to the format of the MPD Request Response as provided in the example of Table 9A and the example schemas illustrated in FIGS. 7C-7D correspond to the format of the MPD Request Response as provided in the example of Table 9B. As illustrated in FIG. 7C, when push_ack has a cardinality of 0 . . . 1, the push_ack may be signaled in the JSON schema as a string as opposed to an array. In JSON, signaling push_{—ack} using a string compared to an array with one entry saves two characters (i.e., two bytes) and as such, requiring push_ack to have a cardinality of 0 . . . 1 may improve the efficiency of system 200.

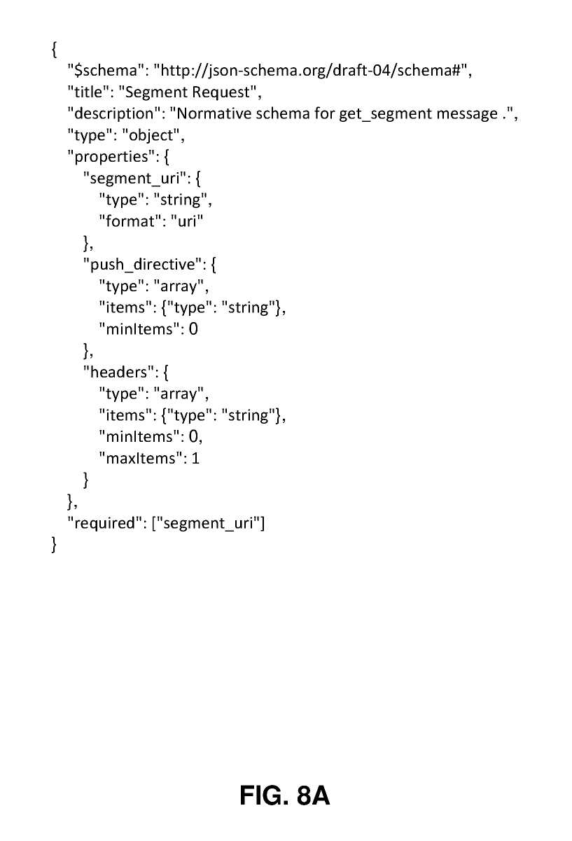

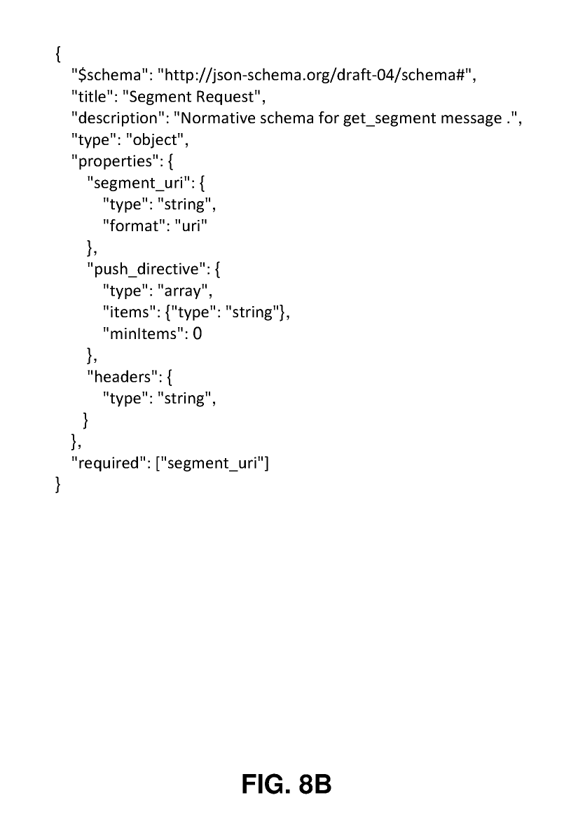

Referring again to FIG. 5, at 506, browser application 310 sends a Segment Request to server application 410. Referring to Table 4, W16232 fails to define a normative JSON schema for the supplied arguments in Table 4. FIGS. 8A-8B are computer program listings illustrating respective example JSON schemas of Segment Request message. In one example, browser application 310 may be configured to send an Segment Request to server application 410 based on the example schemas illustrated in FIGS. 8A-8B.

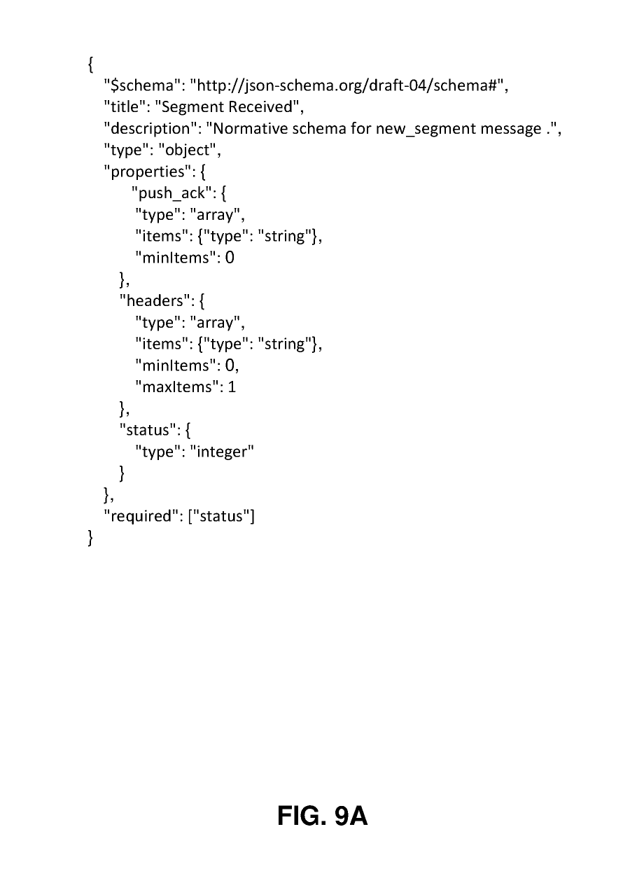

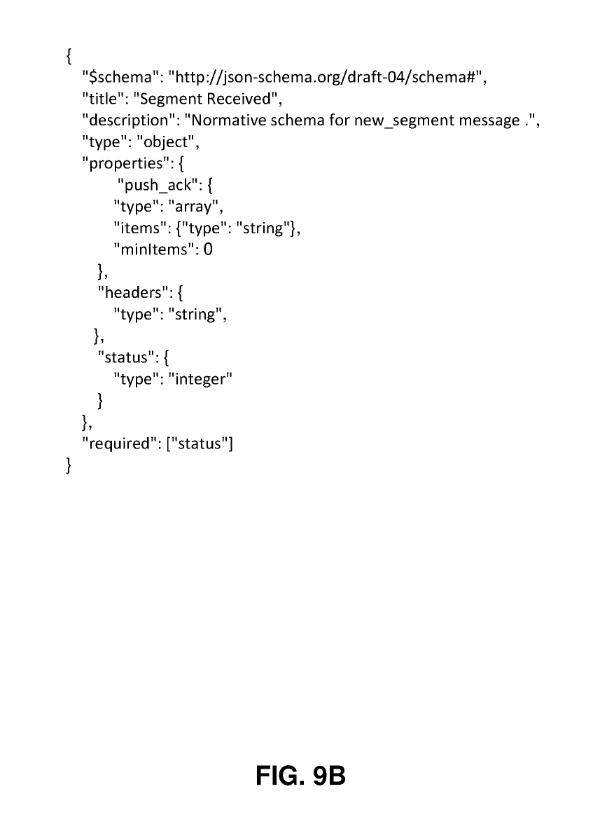

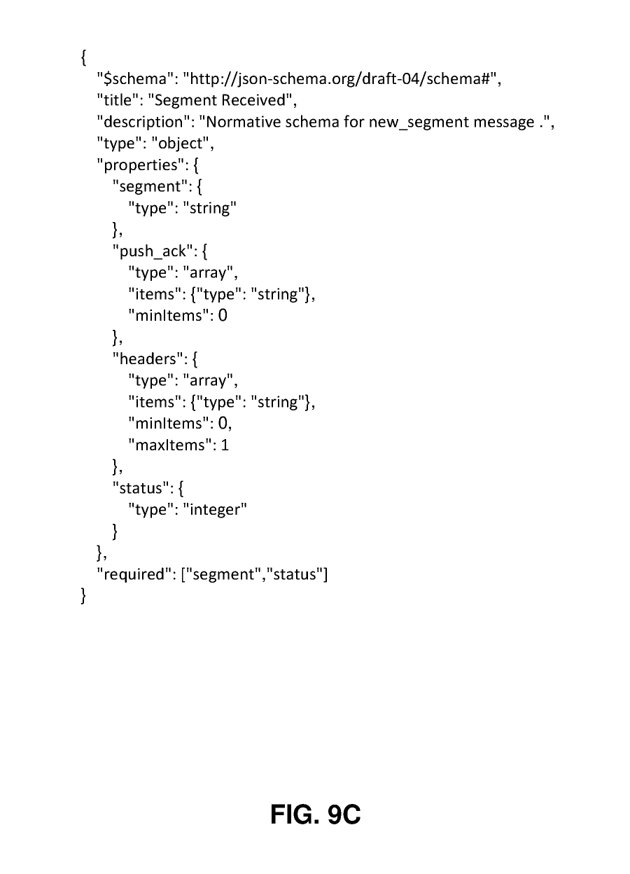

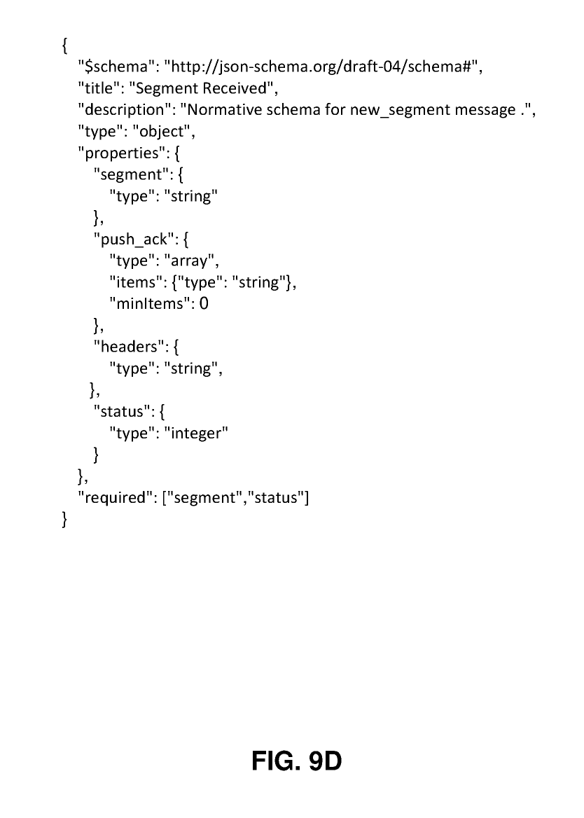

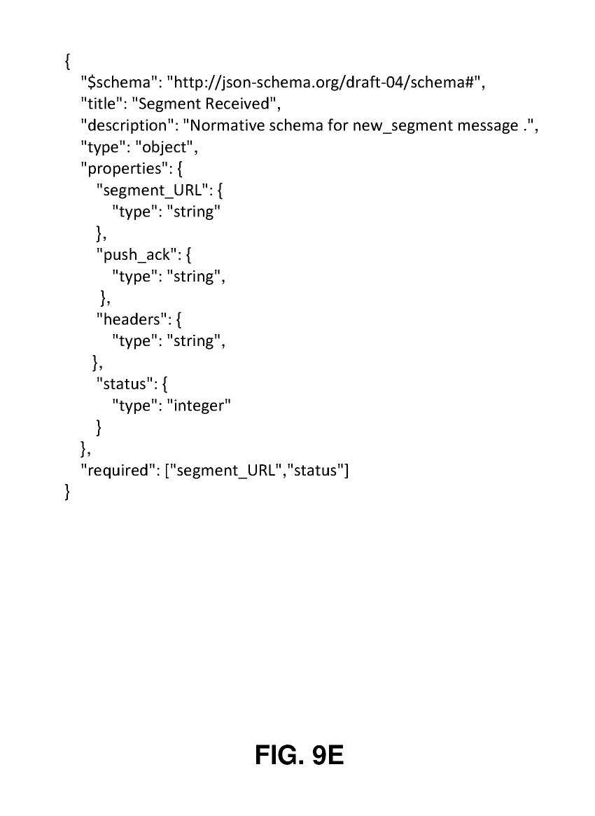

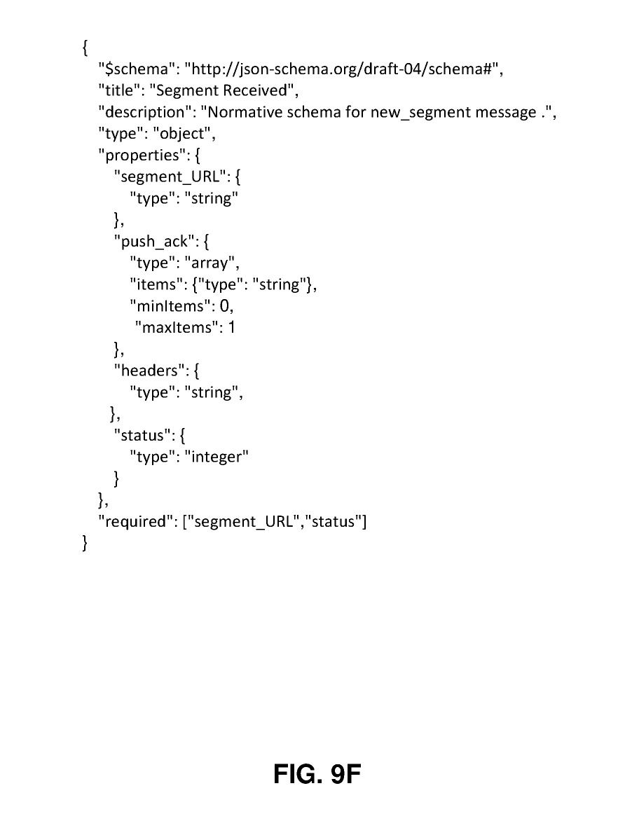

Referring again to FIG. 5, at 508, server application 410 sends a Segment Request Response to browser application 310. Referring to Table 6, W16232 includes “segment” as a parameter with Type “Segment.” This does not completely specify how segment is encoded as JSON encoded parameter since it does not define what JSON data type is used. In one example, server application 410 may be configured to send a Segment Request Response, where the parameter “Segment” is not a supplied argument. In one example, server application 410 may be configured to send the Segment data directly as binary data without JSON encoding after the JSON encoded parameters which include “push_ack,” “headers,” “status.” FIGS. 9A-9B are computer program listings illustrating respective example schemas of a segment request response message. As illustrated in FIGS. 9A-9B, the example schemas do not include parameter “Segment.” It should be noted that in each of the examples illustrated in FIGS. 9A-9B, status may have a integer data type. In one example, server application 410 may be configured to send an Segment Request Response to browser application 310 based on the example schemas illustrated in FIGS. 9A-9B.

In another example, server application 410 may be configured to send the “segment” parameter as JSON data. The segment parameter may be based on the description provided in Table 10A, which may replace the corresponding entry in Table 6.

TABLE 10A

| Parameter | | | |
|---|---|---|---|
| Name | Type | Cardinality | Description |
| Segment | String | 1 | The segment returned by the server. |
| | | | The segment data shall be base64 |
| | | | encoded as described in IETF |
| | | | RFC 4648. The base64 encoded data |
| | | | shall then be JSON encoded as |
| | | | specified by IETF RFC 7158 |
| | | | as JSON data type string. |

FIGS. 9C-9D are a computer program listings illustrating respective example schemas of a segment request response message. As illustrated in FIGS. 9C-9D, the example schemas do include parameter “Segment.” It should be noted that in each of the examples illustrated in FIGS. 9C-9D, status may have an integer data type. In one example, server application 410 may be configured to send a Segment Request Response to browser application 310 based on the example schemas illustrated in FIGS. 9C-9D. In one example, the schemas in FIGS. 9C-9D may be used along with Table 10A.

In another example, server application 410 may be configured to send a Segment Request Response to browser application 310, where the format of the Segment Request Response is defined as provided in Table 10B.

TABLE 10B

| Parameter | | | |
|---|---|---|---|
| Name | Type | Cardinality | Description |
| segment_URL | String | 1 | The segment URL |
| push_ack | PushAck | 0 . . . 1 | The push strategy that the server will |
| | | | follow, e.g., as described section |
| | | | in 6.1.4 [of W16232]. |
| headers | String | 0 . . . 1 | Contains a CRLF separated set of HTTP |
| | | | 1.1 conformant header fields that apply |
| | | | to this message. |
| status | Number | 1 | An HTTP status code, conforming to |
| | | | RFC 7231 section 6, which applies to |
| | | | this message. |

It should be noted that Segment in Table 10A may include a string describing a segment URL and as such, segment_URL in Table 10B may be similar to Segment in Table 10A in some examples. It should be noted that “segment_URL” may instead be called “Segment_URL” in the Tables and Figures. FIGS. 9E-9F are a computer program listings illustrating respective example schemas of a segment request response message. The example schemas illustrated in FIGS. 9E-9F correspond to the format of the Segment Request Response as provided in the example of Table 10B. As illustrated in FIG. 9E, when push_ack has a cardinality of 0 . . . 1, the push_ack may be signaled in the JSON schema as a string as opposed to an array. As described above, in JSON, signaling push_ack using a string compared to an array with one entry saves two characters (i.e., two bytes) and as such, requiring push_ack to have a cardinality of 0 . . . 1 may improve the efficiency of system 200.

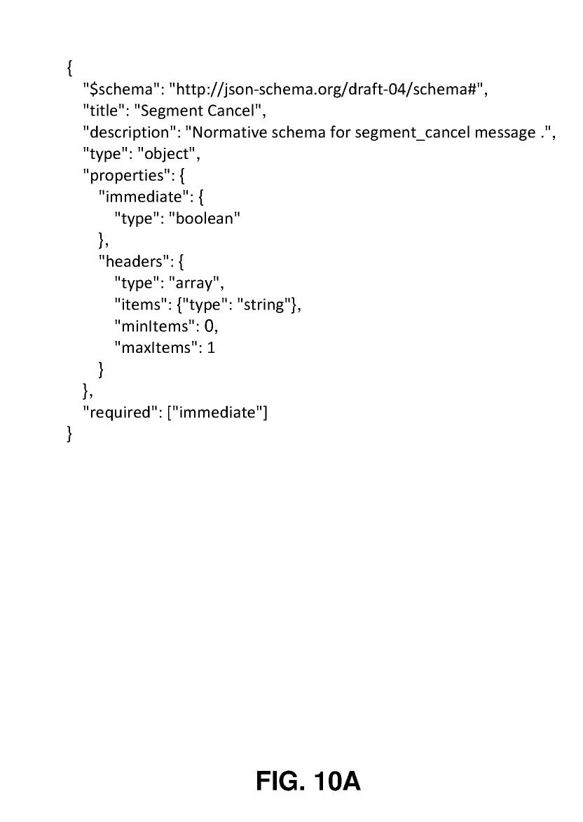

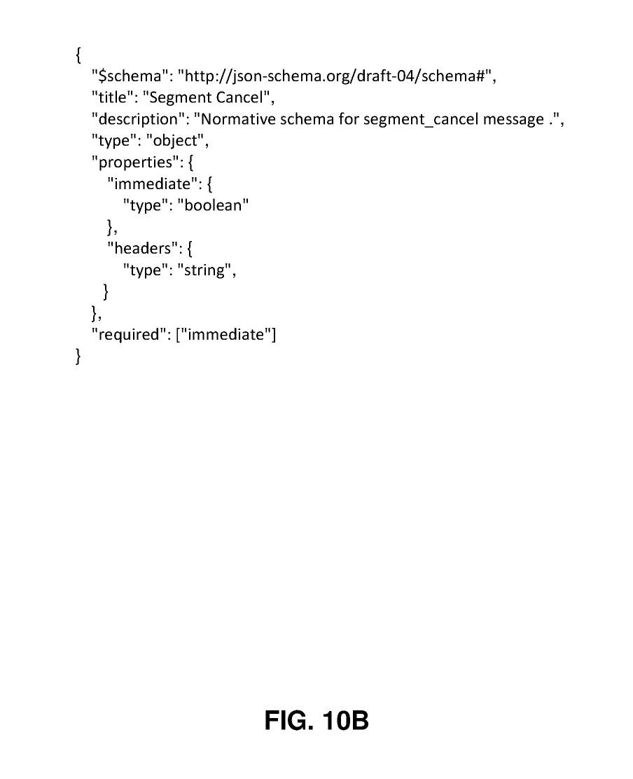

Referring again to FIG. 5, a session may terminated by browser application 310 sending a cancellation request to server application 410 (510) or by server application 410 sending a resource change notification to browser application (512). Referring to Table 8, W16232 fails to define a normative JSON schema for the supplied arguments in Table 8. FIGS. 10A-10B are computer program listings illustrating respective example JSON schemas of a cancellation request message. In one example, browser application 310 may be configured to send a cancellation request message to server application 410 based on the example schemas illustrated in FIGS. 10A-10B.

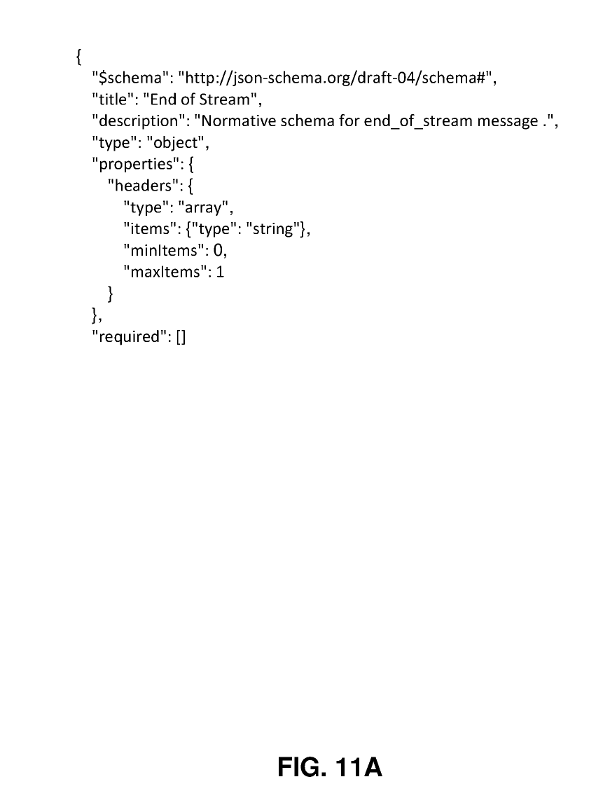

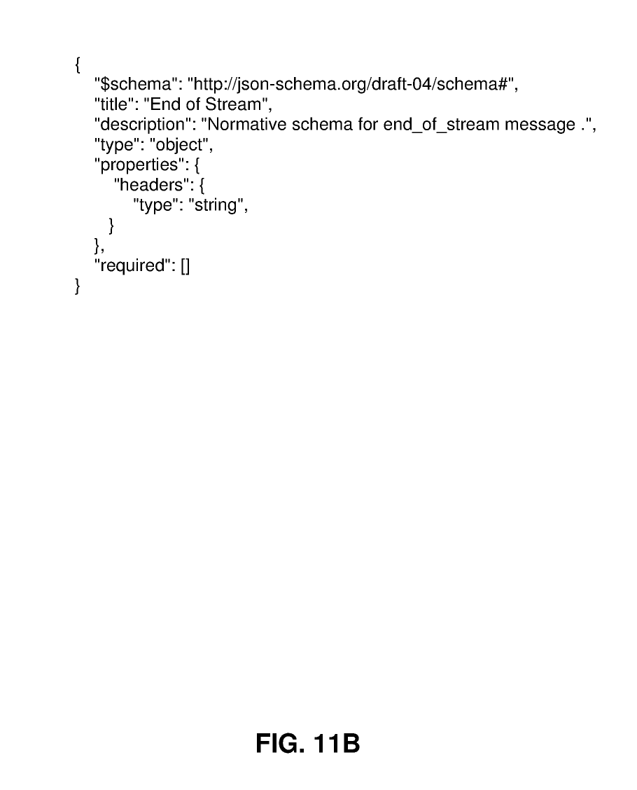

Referring to Table 7, W16232 fails to define a normative JSON schema for the supplied arguments in Table 7. FIGS. 11A-11B are computer program listings illustrating respective example schemas a resource change notification message. In one example, server application 410 may be configured to send a cancellation request message to browser application 310 based on the example schema illustrated in FIGS. 11A-11B. As illustrated in Table 7, the inclusion of header parameters may be optional. In one example, if no headers parameters are included in an instance of an end_of_stream message, then the EXT_LENGTH shall (or should in some examples) be set to 0 in the DASH sub-protocol frame and no empty JSON parameter encoding shall be present after EXT_LENGTH field. It should be noted that in the case where headers parameter is not present including an empty JSON string data with additional required padding to 4-byte boundary is wasteful of bandwidth and requires unnecessary processing. In this manner, computing device 300 and media distribution engine 400 may be configured to exchange messages according to the techniques described herein.

As described above, in W16232, the format of a PushType in the ABNF form is as follows:
PUSH_TYPE=PUSH_TYPE_NAME [OWS “;” OWS PUSH_PARAMS]
PUSH_TYPE_NAME=DQUOTE<URN>DQUOTE
PUSH_PARAMS=PUSH_PARAM*(OWS “;” OWS PUSH_PARAM)
PUSH_PARAM=1*VCHAR

In some cases, the PUSH_PARAM may conflict with JSON reserved characters. For example, VCHAR includes characters DQUOTE (“). JSON uses DQUOTE as a reserved character. In some cases, where PushDirective is signaled as a JSON property, complex parsing may be required. In one example, the grammar of PUSH_PARAM can be defined with some simple changes so as not to interfere with JSON encoding. In one example, browser application 410 and server application 510 may be configured such that, if PUSH_PARAM includes DQUOTE (”), then the DQUOTE shall be escape coded with a preceding ‘\’ (i.e. %×5C).

In another example to handle the double quotes mentioned above following changes may be made to W16232:
Add following in section “3.2 Convention”: PPCHAR=%×21/%×23-7E
Replace occurrences of VCHAR with PPCHAR (in sections 6.1.2 PushType, 6.1.5 URLList, 6.1.6 URLTemplate, and 6.1.7 FastStartParams)
In 6.1.5 (URL Template) change two occurrences of DQUOTE with ‘(single quote, i.e. %×27). And in Table 2 (Valid attributes for FastStartParams) Change occurrences of DQUOTE with ‘ (single quote, i.e. %×27) and occurnces of “with ‘(single quote, i.e. %×27)
   The changes above use single quote instead of double quote character. For this a PPCHAR is defined to exclude the DQUOTE character (%×22).

It should be noted that in W16232, the following Subprotocol-Identifier is used for the WebSocket Subprotocol.

Subprotocol-Identifier: “mpeg-dash”

In some examples, browser application 410 and server application 510 may be configured to provide future extensibility by including a version and/or year in the Subprotocol-Identifier. In one example, a tag based sub-protocol identifier may be defined as follows:

Subprotocol-Identifier: “tag:mpeg.chiariglione.org-dash,2016:23009-6”

In one example, a URN based sub-protocol identifier may be defined as follows:

Subprotocol-Identifier: “urn:mpeg:dash:fdh:2016”

OR

Subprotocol-Identifier: “urn:mpeg:dash:fdh:2016:23009-6”

In one example, subprotocol identifier and subprotocol common name may be defined as follows:

Subprotocol-Identifier: “2016.fdh.dash.mpeg.chiariglione.org”

Subprotocol Common Name: “MPEG-DASH-FDH-23009-6”

In another example to improve robustness of system 200, following changes may be made to W16666:
Add following in section “3.2 Convention”:
   UCHAR=%×21 %×23-7E/%×7C/%×7E;
   and
Define the URLTemplate string format ABNF in 6.1.6 as follows:
   URL_TEMPLATE=TEMPLATE_ITEM*(OWS “;” OWS TEMPLATE_ITEM)
   TEMPLATE_ITEM=SQUOTE TEMPLATE_ELEMENT SQUOTE[OWS “:” OWS “{” OWS TEMPLATE_PARAMS OWS “}”]
   TEMPLATE_ELEMENT=CLAUSE_LITERAL[CLAUSE_VAR[CLAUSE_LITERAL]]
   CLAUSE_LITERAL=1*UCHAR

In one example, the following example constraints may be added to the URLTemplate string format ABNF, when CLAUSE_LITERAL=1*PPCHAR:
If %×7B (“{”) or %×7D (“}”) characters exist in CLAUSE_LITERAL then they shall be escaped by “\”.
OR
If %×7B (“{”) or %×7D (“}”) characters exist in CLAUSE_LITERAL then they shall be percent encoded as defined in RFC 3986 section 2.1.

It should be noted that the example constraints in URLTemplate string format ABNF may be imposed regardless of the specific conventions used with respect to the URLTemplate string format ABNF.

It should be noted that with respect to the definition above of UCHAR:
UCHAR=%×21/%×23-7E/%×7C/%×7E;
This definition may be added at a different place than in section 3.2. For example this definition may be added in URLTemplate—section 6.1.6 instead.
Also in another example, instead of defining and using UCHAR the CLAUSE_LITERAL could be directly defined as:
CLAUSE_LITERAL=1*(%×21/%×23-7E/%×7C/%×7E)

In this manner, computing device 300 and media distribution engine 400 may be configured to exchange messages according to the techniques described herein.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

What is claimed is:

1. A device for signaling information associated with a media presentation, the device comprising one or more processors configured to:
signal a frame header indicating a dynamic adaptive streaming over hypertext transfer protocol message type, wherein the frame header may indicate a media presentation description request response message type or a segment request response message type; and
signal one or more supplied arguments corresponding to a message type, as java script object notation encoded parameters, wherein when the frame header indicates a media presentation description request response message type, one or more supplied arguments include a push acknowledgement parameter having an encoded string data type having a maximum of one instance.

2. The device of claim 1, wherein when the frame header indicates a media presentation description request response message type, one or more supplied arguments include a status parameter having an encoded integer data type.

3. The device of claim 1, wherein signaling one or more supplied arguments corresponding to the message type, as java script object notation encoded parameters, further includes when the frame header indicates a segment request response message type, one or more supplied arguments include a push acknowledgement parameter having an encoded string data type having a maximum of one instance.

4. The device of claim 1, wherein the device includes a media distribution engine.

5. The device of claim 3, wherein the device includes a media distribution engine.

6. The device of claim 1, wherein the device includes a computing device.

7. The device of claim 3, wherein the device includes a computing device.

8. A method for signaling information associated with a media presentation, the method comprising:
signaling a frame header indicating a dynamic adaptive streaming over hypertext transfer protocol message type, wherein the frame header may indicate a media presentation description request response message type or a segment request response message type; and
signaling one or more supplied arguments corresponding to a message type, as java script object notation encoded parameters, wherein when the frame header indicates a media presentation description request response message type, one or more supplied arguments include a push acknowledgement parameter having an encoded string data type having a maximum of one instance.

9. The method of claim 8, wherein when the frame header indicates a media presentation description request response message type, one or more supplied arguments include a status parameter having an encoded integer data type.

10. The method of claim 8, wherein signaling one or more supplied arguments corresponding to the message type, as java script object notation encoded parameters, further includes wherein when the frame header indicates a segment request response message type, one or more supplied arguments include a push acknowledgement parameter having an encoded string data type having a maximum of one instance.

11. A device for parsing information associated with a media presentation, the device comprising one or more processors configured to:
receive a message including a frame header indicating a dynamic adaptive streaming over hypertext transfer protocol message type, wherein the frame header may indicate a media presentation description request response message type or a segment request response message type; and
parse one or more supplied arguments corresponding to a message type, as java script object notation encoded parameters, wherein when the frame header indicates a media presentation description request response message type, one or more supplied arguments include a push acknowledgement parameter having an encoded string data type having a maximum of one instance.

12. The device of claim 11, wherein when the frame header indicates a media presentation description request response message type, one or more supplied arguments include a status parameter having an encoded integer data type.

13. The device of claim 11, wherein parsing one or more supplied arguments corresponding to a message type, as java script object notation encoded parameters, further includes when the frame header indicates a segment request response message type, one or more supplied arguments include a push acknowledgement parameter having an encoded string data type having a maximum of one instance.

14. The device of claim 11, wherein the device includes a computing device.

15. The device of claim 14, wherein the device is selected from the group consisting of: a desktop or laptop computer, a mobile device, a smartphone, a cellular telephone, a personal data assistant (PDA), a television, a tablet device, or a personal gaming device.

16. A method for parsing information associated with a media presentation, the method comprising:
receiving a message including a frame header indicating a dynamic adaptive streaming over hypertext transfer protocol message type, wherein the frame header may indicate a media presentation description request response message type or a segment request response message type; and
parsing one or more supplied arguments corresponding to a message type, as java script object notation encoded parameters, wherein when the frame header indicates a media presentation description request response message type, one or more supplied arguments include a push acknowledgement parameter having an encoded string data type having a maximum of one instance.

17. The method of claim 16, wherein when the frame header indicates a media presentation description request response message type, one or more supplied arguments include a status parameter having an encoded integer data type.

18. The method of claim 16, wherein parsing one or more supplied arguments corresponding to a message type, as java script object notation encoded parameters, further includes when the frame header indicates a segment request response message type, one or more supplied arguments include a push acknowledgement parameter having an encoded string data type having a maximum of one instance.

19. The method of claim 16, further comprising signaling a media presentation description request message.

20. The method of claim 18, further comprising signaling a segment request message.
